(19) United States
(12) Patent Application Publication
(10) Pub. No.: US 2003/0167399 A1
(43) Pub. Date: Sep. 4, 2003

(54) Method and system for performing post issuance configuration and data changes to a personal security device using a communications pipe

(76) Inventors: Yves Audebert, Los Gatos, CA (US); Eric Le Saint, Fremont, CA (US)

Correspondence Address: STEVENS DAVIS MILLER & MOSHER, LLP, 1615 L STREET, NW, SUITE 850, WASHINGTON, DC, 20036, US

(21) Appl. No.: 10/085,127

(22) Filed: Mar. 1, 2002

(51) Int. Cl. H04L 9/32

(52) U.S. Cl. 713/191

(57) ABSTRACT

This invention provides a mechanism for performing secure configuration and data changes between a PSD and a hardware security module (HSM) using a communications pipe established between said PSD and said HSM. The data changes and configuration changes include but are not limited to installing, updating, replacing, deleting digital certificates, cryptographic keys, applets, other digital credentials, attributes of installed objects, or other stored proprietary information.

### CROSS-REFERENCE TO RELATED APPLICATIONS

The present application is related to co-pending U.S. patent application Ser. No. 09/844,246 entitled, “METHOD AND SYSTEM FOR ESTABLISHING A REMOTE CONNECTION TO A PERSONAL SECURITY DEVICE,” filed on Apr. 30, 2001, and co-pending application Ser. No. 09/844,439 “SYSTEM AND METHOD FOR AUTHENTICATION THROUGH A COMMUNICATIONS PIPE,” filed on Apr. 30, 2001, both assigned to the assignee of the present invention. Applicant hereby incorporates by reference the above-mentioned co-pending applications, which are not admitted to be prior art with respect to the present invention by its mention here or in the background section that follows

### FEDERALLY SPONSORED RESEARCH AND DEVELOPMENT

Not Applicable

### REFERENCE TO A MICROFICHE APPENDIX

Not Applicable

### FIELD OF INVENTION

The present invention relates to a data processing method and system for performing post issuance configuration and data changes through a communications path (the “pipe”) established over a communications network between a Personal Security Device (PSD) and a hardware security module (HSM) associated with a server in a way that does not disclose the security mechanisms implemented in the PSD to a local client computer or server.

### BACKGROUND OF INVENTION

The current art involving the use of personal security devices (PSD), for example, smart cards, subscriber identity module (SIMs), wireless identify modules (WIMs), biometric devices, tokens or combinations thereof, requires specialized messaging software or firmware to be installed on a local client in which the PSD is connected. These specialized programs are used to translate from higher level messaging protocols into the low-level messaging packets known in the art as Application Protocol Data Units (APDU) in order to communicate with a PSD.

Placement of the specialized messaging software hereinafter referred to as an APDU interface on local clients, significantly increases the potential for compromising the security of the system since a limitation of the current art requires local generation of cryptographic keys on the local client in order to obtain access to the proprietary information contained inside the PSDs. Local generation of the cryptographic keys and client transactions involving proprietary data are susceptible to interception by covertly installed programs designed to capture the sensitive transactions.

To address some of the limitations in the current art, patent application Ser. No. 09/844,246 entitled, “METHOD AND SYSTEM FOR ESTABLISHING A REMOTE CONNECTION TO A PERSONAL SECURITY DEVICE,” provides a system and method for establishing a communications pipe over a network between a server and a personal security device A client associated with the PSD provides the communications and power interface for the PSD but is not involved in performing transactions with the PSD The generation or retrieval of cryptographic keys necessary to access a secure domain contained inside a target PSD is performed by a hardware security module (HSM) associated with a remote server, thus maintaining end-to-end security.

Patent application Ser. No. 09/844,439 entitled “SYSTEM AND METHOD FOR AUTHENTICATION THROUGH A COMMUNICATIONS PIPE,” provides a system and method for utilizing the communications pipe described in patent application Ser. No. 09/844,246 to securely transfer credentials from the PSD to a server, thus allowing the remote server to act as a proxy for authentication and other proprietary transactions normally performed by the local client and PSD

Both co-pending patent applications provide several advantages over the prior art in their ability to maintain end-to-end secure communications over a public network such as the Internet. Most importantly, transactions are only performed in highly secure and protected domains of a PSD and HSM, which greatly reduce the chances of unauthorized access or interception. Neither co-pending patent application is admitted by the inventor to be prior art.

### BRIEF SUMMARY OF INVENTION

This invention provides a mechanism for performing secure configuration and data changes between a PSD and a hardware security module (HSM) using the communications pipe described in patent application Ser. No. 09/844,246 entitled, “METHOD AND SYSTEM FOR ESTABLISHING A REMOTE CONNECTION TO A PERSONAL SECURITY DEVICE.” The data changes and configuration changes include but are not limited to installing, updating, replacing, deleting digital certificates, cryptographic keys, applets, other digital credentials, attributes of installed objects, or other stored proprietary information.

A communications pipe is established between an HSM and a PSD preferably using a secure messaging protocol such as TCP/IP implementing transport layer security including secure socket layer (SSL) encryption or IPSEC. Once the communications pipe is established, mutual authentications are performed through the pipe using established authentication protocols, typically challenge and response mechanisms.

Cryptographic keys necessary to perform the configuration or data changes are generated within the secure domain of the HSM. This is usually performed by cross referencing the embedded PSD's serial number or other unique identifier associated with the PSD and retrieving or regenerating the proper cryptographic key(s). The cryptographic key(s) may be any combination of symmetric or asymmetric key(s). For simplicity the term cryptographic key will be used hereinafter to identify the combination of symmetric or asymmetric key(s). The HSM version of the cryptographic key is then used to encrypt command strings required to perform the configuration or data changes.

The PSD's secure domain containing the configuration or data to be changed is selected using an application identifier (AID) code The AID identifies a specific application associated with the objects to be manipulated. An APDU command containing the selected AID is sent through the communications pipe which directs the PSD's internal operating system to direct incoming APDU's to the selected application.

Once the target AID is successfully selected, encrypted command strings are encapsulated inside APDUs and sent through the communications pipe to the AID controlling the secure domain The selected application decrypts and executes the incoming command strings using a complementary cryptographic key contained within its associated secure domain. The desired configuration or data change to be accomplished is included in the incoming APDU's encrypted command string Following completion of the configuration or data change a response APDU is returned through the communications pipe to the issuing server signaling the end of the post issuance configuration or change process.

A more detailed explanation of the specific APDU communications protocol, commands and PSD internal file structures is provided in international standard ISO 7816-4, “INFORMATION TECHNOLOGY, IDENTIFICATION CARDS INTEGRATED CIRCUIT(S) CARDS WITH CONTACTS,” Part 4.

### BRIEF DESCRIPTION OF DRAWINGS

A more complete understanding of the present invention may be accomplished by referring to the following Detailed Description and claims, when viewed in conjunction with the following drawings:

FIG. 1—is a generalized system block diagram for implementing present invention;

FIG. 2—is a detailed block diagram depicting the transfer of the proper cryptographic information necessary to access the secure domain containing the target credential;

FIG. 3—is a detailed block diagram depicting the transfer of a credential from a second server over a network for injection into a target PSD

FIG. 4—is a detailed block diagram depicting accessing the secure domain containing the target credential and the interrelationship of the PSD's security executive.

### DETAILED DESCRIPTION OF PREFERRED EMBODIMENT

This invention provides a method and system for performing post issuance configuration and data changes through a communications path (the “pipe”) established over a communications network between a Personal Security Device (PSD) and a hardware security module (HSM) associated with a server in a way that does not disclose the security mechanisms implemented in the PSD to a local client computer or server. Details related to the communications pipe are described in co-pending U.S. patent application Ser. No. 09/844,246 entitled, “METHOD AND SYSTEM FOR ESTABLISHING A REMOTE CONNECTION TO A PERSONAL SECURITY DEVICE,” filed on Apr. 30, 2001 For clarity, specific mention of the pipe server and pipe client API level programs are not specifically included in this application but should be assumed to be present. The data changes and configuration changes include but are not limited to installing, updating, replacing, deleting digital certificates, cryptographic keys, applets, other digital credentials, attributes of installed objects, or other stored proprietary information.

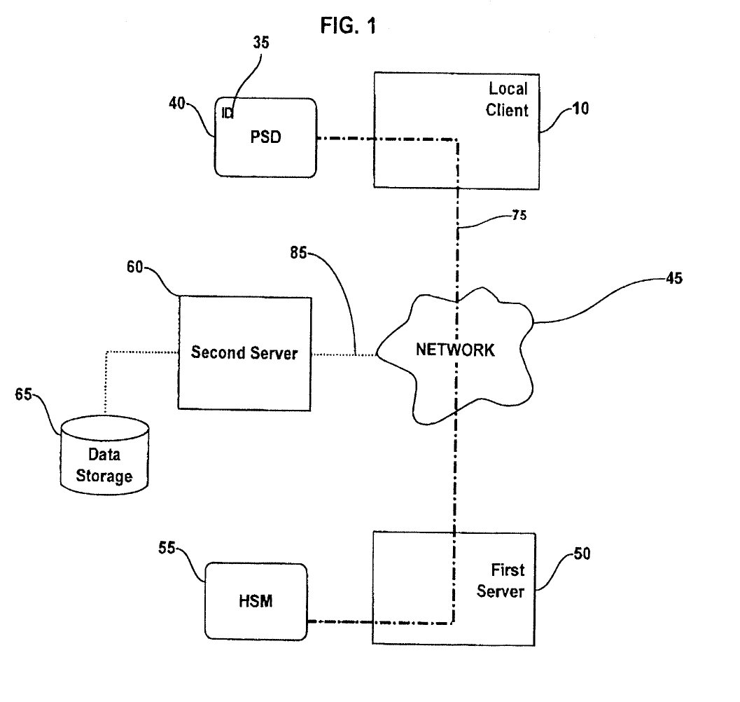

Referring to FIG. 1, a generalized system block diagram of the invention is depicted In FIG. 1, a local client 10 is functionally connected to a PSD 40. The PSD 40 includes a unique identifier ID 35, which is used to determine the proper cryptographic key to access a secure domain contained within the PSD and the configuration or data change to be manipulated in the PSD The PSD 40 is in remote communications with an HSM 55 associated with a first server 50. This remote communications pathway provides the highest degree of end-to-end security by limiting transactions to the secure domains of the HSM 55 and PSD 40.

The first server 50 and local client 10 having been previously and mutually authenticated using a pre-established authentication protocol. Typically, a challenge/response authentication protocol is employed The PSD 40 unique identifier ID 35 is returned to the first server 50 during initial authentication. Communications between the HSM 55 and PSD 10 is accomplished through a communications pipe 75, which routes APDU messages containing encrypted command strings over a network 45 using the local client 10 and first server 50 as communications interfaces.

A previously authenticated second server 60 and associated data storage 65 is connected to the network 45 and in communications 85 with the first server 50. The data storage 65 contains the configuration or data change(s) which are retrievable using the PSD's unique identifier ID 35. This arrangement allows configurations or data changes to originate on any other computer system in networking communications with the first server 50. The network may be either a public or private network. In the preferred embodiment of the invention, all networking communications utilize a secure messaging protocol such as TLS, IPSEC or SSL. Other secure messaging protocols may be employed as well.

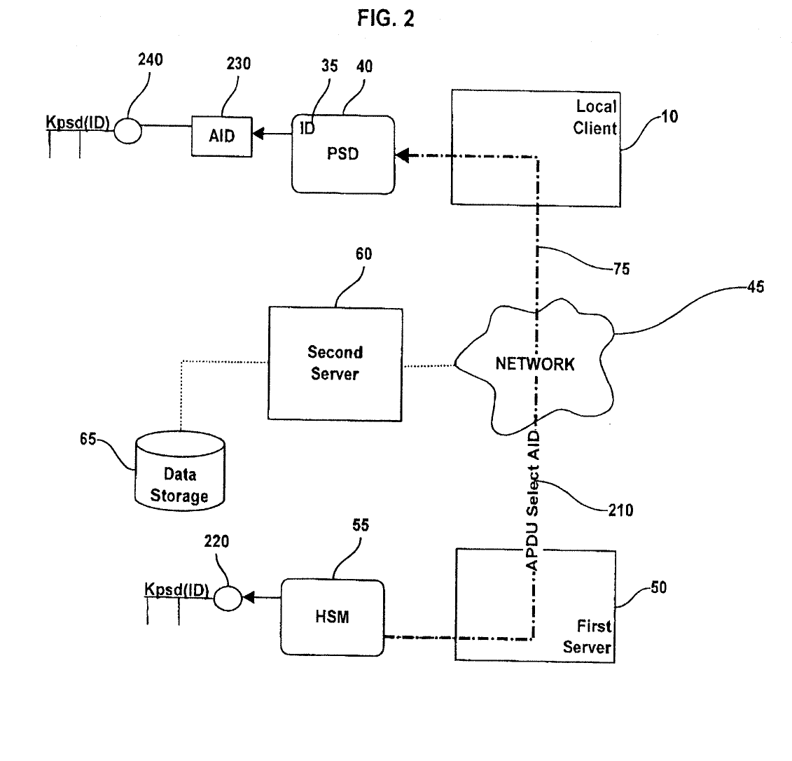

In FIG. 2, to access the secure domain containing the configuration or data to be manipulated, an APDU select command 210 is issued through the communications pipe 75, which selects the proper application identifier AID 230. Once the proper AID 230 has been selected, a cryptographic key Kpsd(ID) 220 is either generated or retrieved by the HSM 55 to encrypt APDU command strings necessary to accomplish the configuration or data change. The proper AID 230 and cryptographic key Kpsd(ID) 220 are determined by using the PSD's unique identifier ID 35 as an index. The key Kpsd(ID) 220 may be either a shared symmetric key or an asymmetric key either of which are complementary to an internal key Kpsd(ID) 240 already present in the PSD 10

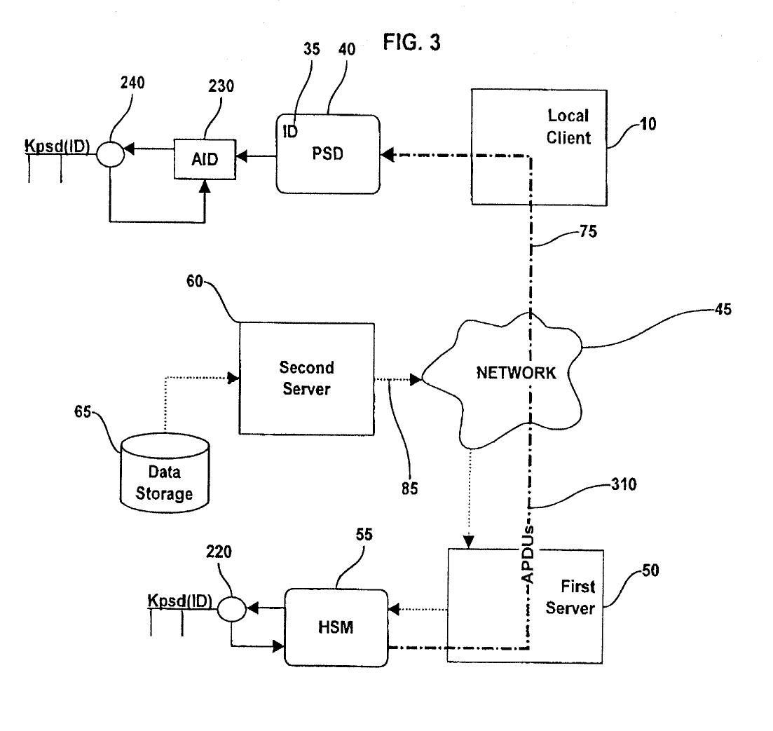

Referring to FIG. 3, configuration or data changes are retrieved from the data storage 65 associated with the second server 60 and securely sent 85 over the network 45 utilizing a secure messaging protocol (e.g. TLS, IPSEC or SSL) where the configuration or data changes are received by the first server 50 and routed into the HSM 55. The HSM 55 encrypts the configuration or data changes using the complementary cryptographic key Kpsd(ID) 220. The encrypted commands and data strings are encapsulated into APDUs 310 and routed through the communications pipe 75 and into the PSD 40 for processing by the application associated with the proper AID 230 It is also envisioned that other authenticated sources of configuration or data changes may be received over the network 45 or supplied directly from the first server 50.

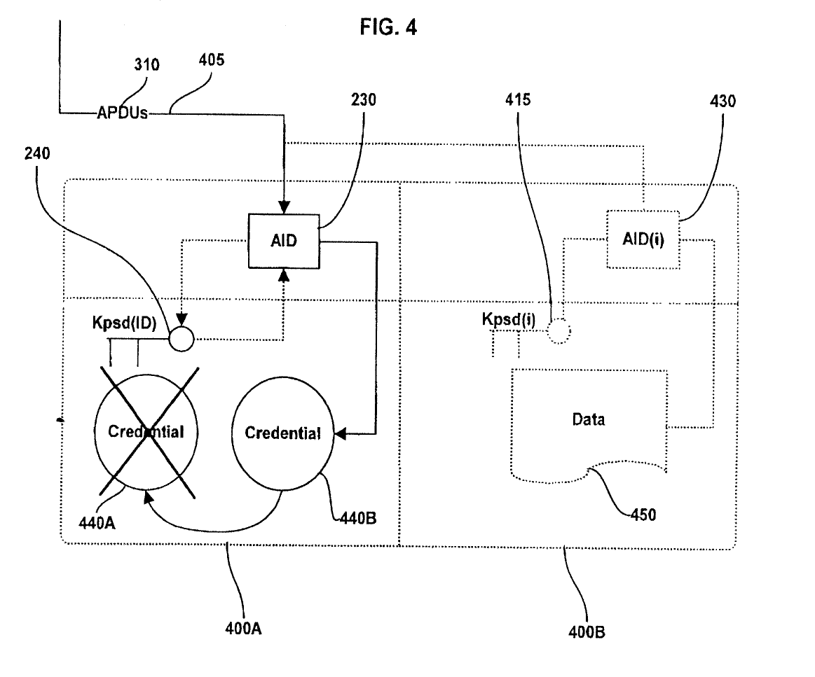

In FIG. 4 incoming APDUs 310 containing the encrypted data strings are routed 405 to the selected application AID 230, sequentially decrypted using the existing cryptographic key Kpsd(ID) 240 and processed by the selected application AID 230. An example configuration or data manipulation is shown where an existing credential 440A is replaced with a new credential 440B by the selected application AID 230. The first incoming command is decrypted using the cryptographic key Kpsd(ID) 240 which instructs the selected application AID 230 to delete the existing credential 440A. A second incoming command and encapsulated credential 440B is decrypted as before and instructs the selected application AID 230 to install the new credential 440B. This sequence continues until the last incoming APDU command has been processed.

Other secure domains 400B within the target PSD, including their associated applications AID(i) 430, cryptographic key 415, and data 450 are not affected by the transactions occurring within the secure domain 400A.

The foregoing described embodiments of the invention are provided as illustrations and descriptions. They are not intended to limit the invention to precise form described. In particular, it is contemplated that functional implementation of the invention described herein may be implemented equivalently in hardware, software, firmware, and/or other available functional components or building blocks.

Other variations and embodiments are possible in light of above teachings, and it is not intended that this Detailed Description limit the scope of invention, but rather by the claims following herein.

What is claimed is:

1 A post issuance system for performing data or configuration changes within a PSD, said system comprising
said PSD, including at least one functional application and PSD cryptographic means,
a local client functionally connected to said PSD,
a first server functionally connected to said local client, said PSD and said first server comprising first means for mutual authentication.
at least one HSM, including HSM cryptographic means complementary to said PSD cryptographic means, said at least one HSM being functionally connected to said first server,
a communications pipe, established between said PSD and said at least one HSM,
storing means for storing or generating said data or configuration changes, said storing means being functionally connected to said first server,
said at least one HSM comprising controlling means for controlling said data or configuration changes sent through said communications pipe to said PSD.

2. The system according to claim 1 comprising a network for the establishment of said communications pipe

3. The system according to claim 1 wherein said at least one functional application includes means for processing APDU commands and said data or configuration changes received through said communications pipe.

4 The system according to claim 1 further including at least one second server in processing communications with said first server, wherein said at least one second server includes stored data or configuration changes retrievable using a PSD unique identifier.

5 The system according to claim 4 wherein said first server and said at least one second server comprise means for mutual authentication

6 The system according to claim 1 wherein said at least one functional application includes an application identifier

7. The system according to claim 6 comprising selecting means for selecting said at least one functional application using said application identifier.

8. The system according to claim 4 comprising a network for the establishment of said communications pipe and for functionally connecting said at least one second server to said first server, and sending means for sending said retrieved data or configuration changes from said at least one second server over said network to said first server.

9. The system according to claim 4 wherein said first server comprises first processing means for receiving and processing said data or configuration changes, and wherein said at least one HSM comprises second processing means for further processing said data or configuration changes.

10. The system according to claim 1 wherein said at least one HSM comprises generating means for generating at least one command executable by said at least one functional application.

11. The system according to claim 10 wherein said at least one HSM comprises encrypting means for encrypting said at least one command and said data or configuration changes, forming at least one cryptogram.

12. The system according to claim 11 comprising sending means for sending said at least one cryptogram through said communications pipe into said PSD for processing by said at least one functional application

13. The system according to claim 12 wherein said at least one functional application comprises decrypting means for decrypting said cryptogram using said PSD cryptographic means, and executing means for executing said at least one command.

14. The system according to claim 2 wherein said network is a public network

15 The system according to claim 2 wherein said network is a private network

16. The system according to claim 1 wherein said communications pipe is provided with a secure communications protocol.

17 The system according to claim 1 wherein said HSM cryptographic means and said PSD cryptographic means comprise complementary asymmetric keys.

18. The system according to claim 1 wherein said HSM cryptographic means and said PSD cryptographic means comprise complementary symmetric keys.

19. A post issuance method for performing data or configuration changes within a PSD, said method comprising
establishing a communications pipe between said PSD and at least one HSM, wherein said PSD is functionally connected to a local client and said at least one HSM is functionally connected to a first server,
mutually authenticating said PSD and said first server,
selecting at least one functional application within said PSD associated with said existing data or configurations.
generating or retrieving HSM cryptographic means complementary to cryptographic means included inside said PSD
retrieving said data or configuration changes.
processing said data or configuration changes by said first server,
encrypting said processed data or configuration changes by said at least one HSM using said complementary HSM cryptographic means,
routing said encrypted processed data or configuration changes through said communications pipe into said PSD, and
decrypting and processing said processed data or configuration changes by said at least one functional application using said PSD cryptographic means.

20 The method according to claim 19, comprising the step of retrieving said data or configuration changes from at least one second server, and of sending said data and configuration changes over a network from said second server to said first server.

21 The method according to claim 19 further including the step of mutually authenticating said at least one second server and said first server.

22. The method according to claim 21, comprising the further step of using a unique identifier associated with said PSD for mutually authenticating said PSD and said first server.

23 The method according to claim 19, comprising the further step of using a unique identifier associated with said PSD for selecting said at least one functional application.

24. The method according to claim 19, comprising the further step of using a unique identifier associated with said PSD for generating or retrieving said HSM cryptographic means.

25. The method according to claim 19, comprising the further step of using a unique identifier associated with said PSD for retrieving said data or configuration changes.

26 The method according to claim 19, wherein at least one command executable by said at least one functional application is issued by said at least one HSM, routed through said communications pipe into said PSD, and processed by said at least one functional application.

27 The method according to claim 19 comprising the step of functionally connecting said local client and said first server through a private network

28 The method according to claim 19 comprising the step of functionally connecting said local client and said first server through a public network.

29. The method according to claim 19 comprising the step of employing asymmetric cryptographic means for said HSM cryptographic means and said PSD cryptographic means

30. The method according to claim 19 comprising the step of employing symmetric cryptographic means for said HSM cryptographic means and said PSD cryptographic means.

31. The method according to claim 19 comprising the step of using a secure communications protocol for said communications pipe.
